(19) United States
(12) Patent Application Publication
(10) Pub. No.: US 2024/0308887 A1
(43) Pub. Date: Sep. 19, 2024

(54) WASTE WATER TREATMENT SYSTEM AND METHOD HAVING A FLOW-THROUGH ELECTROCHEMICAL REACTOR

(71) Applicant: ACLARITY, LLC, North Oxford, MA (US)

(72) Inventor: Orren David Schneider, Plainsboro, NJ (US)

(21) Appl. No.: 18/276,486

(22) PCT Filed: Feb. 11, 2022
(86) PCT No.: PCT/US2022/016169

§ 371 Date: Aug. 9, 2023

Related U.S. Application Data
(60) Provisional application No. 63/148,986, filed on Feb. 12, 2021.

(51) Int. Cl. C02F 1/467; C02F 1/461; C02F 103/00

(52) U.S. Cl. CPC C02F 1/467; C02F 1/46109; C02F 2001/46133; C02F 2001/46171; C02F 2103/005; C02F 2301/046

(57) ABSTRACT

A wastewater treatment system includes a wastewater tank having a distribution chamber and a treatment chamber. The distribution chamber has a treated wastewater outlet and a recirculation circuit inlet. The treatment chamber has an untreated wastewater inlet and a recirculation circuit exit. Recirculation circuit piping connects the recirculation circuit inlet to the recirculation circuit exit. A pump is fluidly connected to the recirculation circuit inlet and the pump is adapted to pump a portion of wastewater from the distribution chamber to the treatment chamber through the recirculation circuit. A flow-through electrochemical reactor is disposed in the recirculation circuit. The flow-through electrochemical reactor electrochemically remediates undesirable chemical compounds in wastewater flowing through the recirculation circuit, thereby purifying the wastewater in the system.

### FIELD OF THE DISCLOSURE

The disclosure relates to liquid purification devices and methods and more specifically to wastewater treatment systems and methods having a flow-through electrochemical reactor.

### BACKGROUND

Biological waste produced by human habitation has long presented a health problem. Generally, when many living and working areas are close to one another, for instance in cities and towns, sewage is gathered and transported to a remote area for further processing in a municipal water treatment facility. These large facilities are capable of remediating many of the problematic aspects of the produced sewage, but are generally only economically viable in denser population area.

People living in less densely populated areas, or facilities present in such areas, often are required to treat or process their sewage locally, usually on their own property. This treatment is often accomplished by using treatment systems such as septic tanks and cesspools. Septic tanks and cesspools generally rely on biological activity (e.g., bacteria) to break down solid waste in the sewage while the liquid portion is released into the earth, the earth filtering the released portion as it descends towards the local water table. Over time, as the water sinks in the earth, it is further filtered and purified by natural processes such that it is relatively safe when it finally reaches the local water table. However, septic tanks and cesspools can leave large amounts of ammonia and organic nitrogen compounds (and other dissolved compounds) in the released water that are transformed into nitrates when released into the earth. This nitrogen can provide excessive nutrients for algae and cyanobacteria, which create nitrate, nitrite, and NOₓ, thereby enhancing unwanted blooms of these microorganisms in the water table such that the compounds and/or microorganisms are present at potentially harmful concentrations when the water is drawn from the water table for use in farming, industrial, or personal needs. Thus, these unwanted blooms can themselves present health problems to humans, animals and plants in the local area, especially to local inhabitants that use water from the local water table, such as by drawing from a well.

As nitrate, nitrite, and NOₓ contamination of groundwater becomes an increasingly dangerous problem, local governments are beginning to establish policies to help mitigate the nitrates, nitrites, and NOₓ contamination. The cost of gathering sewage otherwise processed in septic tanks and treating it in centralized municipal wastewater treatment facilities capable of processing organic nitrogen and ammonia (and therefore mitigating nitrates, nitrites, and NOₓ contamination) is prohibitively expensive and has been estimated to cost between 5 and 10 Billion US dollars for the Long Island area of New York alone. As a result, lawmakers have begun offering incentives to increase adoption of residential and industrial organic nitrogen and ammonia mitigation systems and increased regulatory oversight of organic nitrogen and ammonia release from residential systems is more likely in the future. Other locations in the United States, including the Gulf Coast and Chesapeake Bay, are also impacted by nitrogen pollution.

### SUMMARY OF THE DISCLOSURE

According to a first example, a wastewater treatment system includes a wastewater tank having a distribution chamber and a treatment chamber. The distribution chamber includes a treated wastewater outlet and a recirculation circuit inlet. The treatment chamber includes an untreated wastewater inlet and a recirculation circuit exit. Recirculation circuit piping connects the recirculation circuit inlet to the recirculation circuit exit. A pump is fluidly connected to the recirculation circuit inlet and the pump is adapted to pump a portion of wastewater from the distribution chamber to the treatment chamber through the recirculation circuit. A flow-through electrochemical reactor is disposed in the recirculation circuit. The flow-through electrochemical reactor electrochemically remediates undesirable chemical compounds in wastewater flowing through the recirculation circuit, thereby purifying the wastewater in the system.

According to a second example, a wastewater treatment system includes a wastewater tank having a distribution chamber and a treatment chamber. The distribution chamber includes a treated wastewater outlet and a flow-through outlet. The treatment chamber includes an untreated wastewater inlet and a flow-through inlet. Flow-through piping connects the flow-through inlet to the flow-through exit. A pump fluidly connects the flow-through piping. The pump pumps a portion of wastewater from the treatment chamber to the distribution chamber through the flow-through piping. A flow-through electrochemical reactor is fluidly connected to the flow-through piping. The flow-through electrochemical reactor electrochemically remediates undesirable chemical compounds in wastewater flowing through the flow-through piping.

According to a third example, a method of removing undesirable chemical compounds from wastewater in a wastewater treatment system includes introducing wastewater into a wastewater tank having a treatment chamber and a distribution chamber. A portion of the wastewater from the distribution chamber is pumped through a recirculation circuit. Undesirable chemical compounds in the portion of the wastewater in the recirculating circuit are electrochemically remediated by passing the portion of the wastewater through a flow-through electrochemical reactor.

The foregoing examples of systems and methods for treating wastewater with a flow-through electrochemical reactor may further include any one or more of the following optional features, structures, and/or forms.

In one optional form, the pump is a submersible pump.

In another optional form, the pump is a pump disposed in the distribution chamber.

In yet another optional form, the wastewater tank is one of a septic tank, a cesspool, an industrial water treatment tank, or a municipal water treatment tank.

In yet another optional form, the treatment chamber comprises an existing cesspool and the distribution chamber comprises a separate in-ground tank.

In yet another optional form, the distribution chamber is separated from the treatment chamber by a divider.

In yet another optional form, a baffle is connected to one of the wastewater inlet or the wastewater outlet.

In yet another optional form, the flow-through electrochemical reactor comprises at least one electrode and at least one cathode.

In yet another optional form, the flow-through electrochemical reactor comprises a housing including a solution flow-path, a first electrode disposed within the solution flow-path, a second electrode spaced apart from the first electrode creating an electroactive gap between the first electrode and the second electrode.

In yet another optional form, the electroactive gap is preferably less than 5 mm and greater than 2 mm, more preferably less than about 4 mm and greater than about 2.5 mm, and even more preferably an average size of about 3 mm.

In yet another optional form, the first electrode is an anode having a hollow cylindrical shape.

In yet another optional form, the second electrode is a cathode having a hollow cylindrical shape.

In yet another optional form, the first electrode has an annulus shape and the second electrode has an annulus shape, and the first electrode and the second electrode are arranged concentrically, the first electrode being located within a wall of the second electrode.

In yet another optional form, the first electrode is an anode comprising a solid tubular element and the second electrode is a cathode having a hollow cylindrical shape at least partially surrounding the anode. In some optional forms, the wastewater may flow from outside of the cathode inward towards the anode and then parallel to the outer surface of the anode.

In yet another optional form, the solution flow path extends radially, through a wall of the first electrode, radially across the electroactive gap, and radially through a wall of the second electrode.

In yet other optional forms, the cathode may have a cylindrical wall including a plurality of openings and/or the anode may have a cylindrical wall including a plurality of openings.

In other optional forms, the solution flow path extends at least partially within the anode, longitudinally along an anode longitudinal axis, and at least partially radially outward, through a wall of the anode, substantially perpendicular to the anode longitudinal axis.

In other optional forms, the solution flow path extends radially, through a wall of the anode, radially across the electroactive gap, and radially through the plurality of openings in the cathode wall.

In yet another optional form, a power source is connected to the first electrode and to the second electrode thereby creating an electrical circuit. In other embodiments, the electrical circuit may comprise more than two electrodes.

In yet another optional form, the second electrode comprises one of stainless steel, graphite, or other carbonaceous materials, dimensionally stable anode (DSA), Magneli-phase titanium oxide, mixed metal oxide, or boron doped diamond (BDD).

In yet another optional form, the first electrode comprises one of dimensionally stable anodes (DSA), Magneli-phase titanium oxide, mixed metal oxides, or boron doped diamond (BDD).

In yet another optional form, a portion, or all, of wastewater may be returned to the treatment chamber after passing through the flow-through electrochemical reactor.

In yet another optional form, a portion, or all, of the wastewater may be reintroduced into one of the distribution chamber and the treatment chamber after passing through the electrochemical reactor either by releasing above a surface of the wastewater in the wastewater tank, releasing below a surface of the wastewater in the wastewater tank, releasing in a sludge layer at a bottom of the wastewater tank, or releasing in a scum layer at a top of the wastewater in the wastewater tank.

In yet another optional form, the undesirable chemical compounds comprise one of ammonia, Total Kjeldahl Nitrogen (TKN), biological oxygen demand (BOD), chemical oxygen demand (COD), pharmaceutical and personal care products (PPCPs), anthropogenic organic compounds, metal oxyanions, metal ions, or combinations thereof.

In yet another optional form, concentrations of the undesirable chemical compounds are lowered without the addition of other chemicals.

In yet another optional form, additional chemicals, such as an electrolyte salt, are added upstream of the flow-through electrochemical reactor, or directly into the flow-through electrochemical reactor.

In yet other optional forms, the flow-through electrochemical reactor may include an inlet cap at a first end of the housing, the inlet cap relative spacing and alignment of the anode relative to the cathode.

In yet other optional forms, the flow-through electrochemical reactor may include an outlet guide flow cap at a second end of the housing, the outlet guide flow cap sealing the second end of the housing and receiving outlet flow from the exterior of the cathode, the outlet guide flow cap also sealing one end of the hollow anode.

In yet other optional forms, the flow-through electrochemical reactor may include an adapter base inlet disposed at a first end of the housing, the adapter base providing plumbing and electrical connections while maintaining a pressure seal.

### BRIEF DESCRIPTION OF THE DRAWINGS

While the specification concludes with claims particularly pointing out and distinctly claiming the subject matter, which is regarded as forming the present invention, the invention will be better understood from the following description taken in conjunction with the accompanying drawings.

FIG. 1 is a schematic diagram of a wastewater treatment system having a flow-through electrochemical reactor.

FIG. 2 is a schematic diagram of an alternate embodiment of a wastewater treatment system having a flow through electrochemical reactor.

FIG. 3 is a schematic diagram of yet another alternate embodiment of a wastewater treatment system having a flow-through electrochemical reactor.

FIG. 4 is an exploded perspective view of a flow-through electrochemical reactor that may be employed in any of the wastewater treatment systems of FIGS. 1-3.

FIG. 5 is a side view of the flow-through electrochemical reactor of FIG. 4.

FIG. 6 is side cross-sectional view of the flow-through electrochemical reactor of FIG. 5.

FIG. 7 is a close-up side cross-sectional view of an inlet cap of the flow-through electrochemical reactor of FIG. 4.

FIG. 8 is a close-up side cross-sectional view of an outlet cap of the flow-through electrochemical reactor of FIG. 4.

### DETAILED DESCRIPTION

The wastewater treatment systems and methods described herein include flow-through electrochemical reactors and are advantageously used for treatment of water including, but not limited to, treating municipal or domestic wastewater, and/or treating industrial wastewater. In certain embodiments described herein, the wastewater treatment systems and methods are directed to treating “grey” or “black” water produced in residential or commercial buildings, for example in septic systems or in cesspools. More specifically, grey or black water generated by residential or commercial buildings that do not have access to community or municipal treatment facilities is directed to septic systems or cesspools for treatment before being released back into the environment, typically underground. Grey water, as used herein, means any wastewater that has not come into contact with solid human or animal waste. Black water, as used herein, means waste water that has come into contact with solid human or animal waste. Both grey water and black water are treated by septic systems and cesspools, often simultaneously.

The wastewater treatment systems and methods described herein are advantageously retrofittable to existing wastewater treatment systems, thereby saving time and expense by partially utilizing existing systems. The wastewater systems and method described herein advantageously comprise flow-through electrochemical reactors, which are durable and scalable to meet relatively small personal or domestic demands as well as relatively large consumer, commercial, municipal or industrial demands. Advantageously, the flow-through electrochemical reactors have few moving parts, moving parts being essentially limited to a circulation pump, and therefore have long useful lives, while being relatively inexpensive and easy to manufacture. Moreover, the flow-through electrochemical reactors surprisingly and unexpectedly can more efficiently treat contaminants present in the water/solution being treated, with significantly less clogging and short-circuiting compared to previous devices, as explained in more detail herein.

As used herein, a flow-through electrochemical reactor refers to a reactor having a solution flow-path there through. The basic structural elements of a flow-through reactor include a housing having an inlet, an outlet, anodes, and cathodes are described and shown in US Patent Publication No, 2019/0284066, which is hereby incorporated by reference in its entirety. Flow-through electrochemical reactors are known to be susceptible to fouling and short circuiting because of solids agglomerating in the electroactive gap. As a result, most electrochemical systems utilize relatively larger electrode gaps (at least 5 mm or greater) and/or are constructed and arranged as static (non-flowing) systems to limit fouling risk. The flow-through electrochemical reactors described herein have electrode gaps of less than 5 mm, but greater than 2 mm. In other embodiments, the flow-through electrochemical reactor may include an electroactive gap of less than about 4 mm and greater than about 2.5 mm, preferably about 3 mm. The aforementioned electrode gap ranges have surprisingly and unexpectedly proved to deliver a very high level of electrochemical efficiency without becoming clogged and potentially short circuiting as described herein. Thus, the electroactive gaps disclosed herein surprisingly allow a flow-through electrochemical reactor to more efficiently treat contaminants, while advantageously demonstrating improved electrical efficiency without significant fouling. Furthermore, the electroactive gap of less than 5 mm advantageously produces a desirable mix of reactive oxidants. For example, the electrochemical reactions according to the disclosure advantageously produce a higher concentration of hydroxyl radicals, which leads to more efficient water treatment.

The disclosed wastewater treatment systems and methods, including flow-through electrochemical reactors, can be advantageously used to treat various types of water including grey or black waste water (e.g., domestic waste water, commercial waste water, municipal waste water, industrial waste water). These systems and methods may also be used to advantageously treat, rain water, lake water, river water, or ground water, for multiple end uses.

The disclosed wastewater treatment systems and methods utilize electricity to effect water purification. Specifically, oxidants and disinfectants including but not limited to hydroxyl radicals, free chlorine, and ozone are produced on or near the anode surface of the flow-through electrochemical reactors, which can destroy contaminants such as pathogens and other unwanted organic and inorganic materials (collectively referred to as “contaminants” herein). Contaminants such as nitrates and metal ions can also be chemically reduced on the cathode surface of the flow-through electrochemical reactor, thereby transforming these unwanted contaminants to less harmful compounds, without added chemicals. Thus, the disclosed wastewater treatment systems and methods may be used to treat water with complex water chemistry, for example, by neutralizing acidic and basic contaminants, oxidizing other contaminants, and removing still other contaminants by reduction. Further, the electrodes employed in the wastewater systems are not consumed by the reactions, which drastically reduces the maintenance requirements and as well as the cost of replacement. As a result, fouling or scaling of the electrodes by agglomeration of organic matter, or by precipitation of metals, can advantageously be reversed by reversing the polarity of the electrodes, backwashing with water, adding sodium chloride to feed water and increasing voltage, or by cleaning with a mild acid or base.

During water treatment with the disclosed wastewater treatment systems and methods, water is oxidized to form secondary reactive oxygen species (ROS) such as hydroxyl radicals and ozone. The generated oxidants react quickly with most organic matter that is present in the water/solution being treated, thereby forming carbon dioxide and less harmful byproducts. In addition, direct destruction of contaminants occurs when electrons are transferred from the contaminant to the anode. Perfluorinated compounds such as perfluorooctanoic acid (PFOA) and perfluorooctanesulfonic acid (PFOS) are representative contaminants that can be oxidized using the flow-through electrochemical reactors according to the disclosure. Free chlorine may also be formed in situ from any ambient chloride ions present in the solution to be treated, or from added metal chloride, such as sodium chloride (NaCl), and thus provide another disinfectant. In addition to powerful oxidation and disinfection capabilities, the cathode produces reductants that can reduce unwanted contaminants, thereby causing them to degrade and/or to form less harmful compounds. The combination of oxidant formation, indirect secondary oxidation, direct electron transfer and reduction processes are capable of purifying water including numerous types of contaminants including but not limited to ammonia, total Kjeldhl nitrogen (TKN, which provides a measurement of the sum of the nitrogen from organic compounds (organic nitrogen) and the nitrogen from ammonia/ammonium but does not include nitrogen from other inorganic compounds, such as nitrate or cyanides), biological oxygen demand (BOD), chemical oxygen demand (COD), pharmaceutical and personal care products (PPCPs), other anthropogenic compounds, nitrate, nitrite, metal oxyanions, metal ions, perfluorinated compounds, natural and synthetic organic compound, and pathogens, and combinations thereof. While the free chlorine is a powerful disinfectant, the amount of chlorine produced by the disclosed systems is small enough, and confined to a limited space, that when released back into the septic tank or cesspool, the chlorine is rapidly diluted and consumed, thereby preventing interference with normal biological activity in septic tanks and cesspools. Additionally, the chlorine may be released in the scum layer on the wastewater surface in the septic tank or cesspool, or in the sludge layer at the bottom of the septic tank or cesspool to minimize its detrimental effect on the normal biological activity.

Changes in pH occurring on the electrode surfaces due to the electrolysis of water can cause changes in the pH of the influent water. Typically. H⁺ is formed at the cathode and OH is formed at the anode, both at relatively high quantities. Oxidation occurring at the anode can cause the complete or partial mineralization of many organic compounds, resulting in the formation of CO₂. The formed CO₂ is dissolved in the influent water, thereby creating carbonic acid (H₂CO₃), which lowers the pH. pH also may be lowered by the destruction of ammonia. Thus, changes in pH are, at least in part, dependent on the chemistry of the influent water. Further, formation of hydronium and hydroxide species may be sufficiently high that, coupled with the various redox processes mentioned above, pathogens including bacteria, viruses, and protozoa cannot survive.

Although not necessary, the wastewater to be treated may include added metal salts to facilitate electrochemical processes. For example, the wastewater may include a metal salt, which can provide a source of chloride ions that can be oxidized to form chlorine gas, a powerful oxidant, in situ. Chlorine gas is highly soluble in water and undergoes hydrolysis to form hypochlorous acid (HOCl). Chlorine dioxide (ClO₂) may also be formed in some cases. Salts, such as NaCl, or other salts, may be introduced upstream of the electrochemical reactor and/or may be present in the wastewater itself.

“About,” “approximately,” or “substantially” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about,” “approximately,” or “substantially” can mean within one standard deviation, or within ±10%, 5%, 3%, or 1% of the stated value.

“Carbonaceous” as used herein means a material that comprises carbon. To be considered “carbonaceous” as used herein, a material should contain carbon with carbon atoms in other than a +4 oxidation state (such that the carbon atoms are capable of being oxidized). For example, carbonaceous materials include, but are not limited to, graphite, graphene, fullerenes, electrically conductive plastics, and diamond.

“Flow-through” anode or cathode as used herein refers to an anode or cathode electrode through which liquid is capable of flowing. Some non-limiting examples of flow-through electrodes include anodes or cathodes having an inner through path and/or comprising perforations, pores, or holes through which liquid can flow. The holes may be manufactured in the electrode by punching, for example. In one example, a solid but hollow cylindrical electrode may have an inner through path in which liquid can flow axially along a length of the hollow cylindrical electrode. Other non-limiting examples include anodes having a material wall comprising a porous material, for example, a hollow cylindrical anode or cathode having a material wall comprising a porous material through which liquid can flow both axially along the length of the anode or cathode as well as laterally through the cylindrical anode or cathode wall. Porous electrodes, for example, porous Magneli-phase, e.g., Ti₄O₇, anodes, are generally preferred in that they provide high surface area and increased contact with the water/solution to be electrochemically treated (typically, water), which is advantageous for producing relatively increased amounts of oxidants such as hydroxyl radicals and ozone that can react with contaminants within the water/solution being treated as well as causing relatively increased oxidation of the contaminants. Solid plate-type anodes (that are not hollow and do not have an inner flow-through path) may also be used. Thus, both anodes and cathodes may be flow-through or solid.

In order for any electrochemical process to operate, there must be two (or more) electrodes functioning as anodes and cathodes. “Electroactive gap” as used herein means a gap or space between the electrodes functioning as the anode(s) and the cathode(s). In the disclosed wastewater treatment systems, the electroactive gap in the flow-through electrochemical reactor is included in the flow path through which the wastewater, typically an aqueous phase to be treated, may flow and electrons may be transferred when the electrodes of the electrochemical reactors are powered. The current flow can cause various chemical reactions to take place within the electroactive gap that cause contaminants in the wastewater being treated to degrade and/or be rendered inactive, thereby purifying the wastewater and allowing the effluent stream to be released to the environment.

“Dimensionally stable anode” as used herein refers to an anode that displays relatively high conductivity and corrosion resistance. Generally, dimensionally stable anodes are manufactured from one or more metal oxides such as RuO₂ (ruthenium oxide), IrO₂ (iridium oxide), SnO (tin oxide) or PtO₂ (platinum oxide).

“Mixed metal oxide electrodes” (which may be used as the anode or as the cathode) are made by coating a substrate, such as a titanium plate or an expanded mesh, with several metal oxides. One oxide is usually RuO₂ (ruthenium oxide), IrO₂ (iridium oxide), SnO (tin oxide) or PtO₂ (platinum oxide), which conducts electricity and catalyzes the desired reactions such as the production of chlorine gas in situ. The other exterior coatings the metal oxide is typically titanium dioxide which does not significantly conduct or catalyze, but prevents corrosion of the interior.

In some embodiments, an optional pre-filter may be installed upstream of electrodes and/or a post-filter may be added downstream of the electrodes, the pre or post-filter capturing particles or various inorganic or organic materials thereby preventing the particles from creating short circuiting bridges between electrodes, and/or by removing particles formed by the electrochemical reactions.

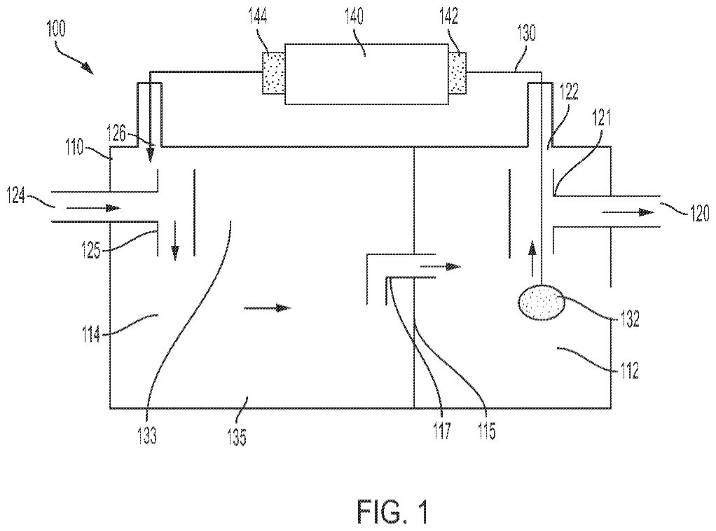

Turning now to FIG. 1, a first embodiment of a wastewater treatment system 100 is illustrated. The wastewater treatment system 100 includes a wastewater tank 110 having a distribution chamber 112 and a treatment chamber 114. The wastewater tank 110 illustrated in FIG. 1 comprises a septic system tank. In other embodiments, the wastewater tank 110 may comprise a municipal wastewater tank. The distribution chamber 112 and the treatment chamber 114 may be fluidly separated by partition or a divider 115 that has a transfer baffle 117 so that liquid can flow from the treatment chamber 114 to the distribution chamber 112. For the purposes of this disclosure, a baffle is a barrier that prevents buoyant particles, which could cause clogs in leach field lines, from reaching the leach field of a septic tank or a cesspool.

The distribution chamber 112 includes a treated wastewater outlet 120 and a recirculation circuit inlet 122. The treated wastewater outlet 120 may be connected to a distribution baffle 121.

The treatment chamber 114 includes an untreated wastewater inlet 124 and a recirculation circuit exit 126. The untreated wastewater inlet 124 may be connected to a treatment baffle 125.

Recirculation circuit piping 130 (which forms a recirculation circuit) connects the recirculation circuit inlet 122 to the recirculation circuit exit 126. A pump 132 is fluidly connected to the recirculation circuit inlet 122 and the pump 132 is adapted to pump a portion of wastewater from the distribution chamber 112 to the treatment chamber 114 through the recirculation circuit piping 130. In the embodiment of FIG. 1, the pump 132 is a submersible pump that is located below a surface 133 of liquid in the distribution chamber 112. The pump 132 is located above a layer of sludge 135 formed by solid matter that settles out of the wastewater over time. In other embodiments, the pump 132 may be a different type of pump (e.g., a wiz-bang pump, a positive displacement (non-submersible) pump, a suction pump, or the like), and/or the pump 132 may be located at another point in the system (e.g., above the surface 133 of the wastewater in either the treatment chamber 114 or the distribution chamber 112, or in the recirculation piping 130).

In other embodiments, the pump 132 may include a level or float switch and control, or a timer and a level switch, that turns the pump off when fluid level is low to prevent dewatering of the distribution chamber 112. In yet other embodiments, the pump 132 may include a temperature sensor that senses freezing temperatures in the pump 132 or in the recirculation circuit piping 130, to turn off the pump 132 in the event of freezing conditions that could freeze liquid in the pump 132 or in the recirculation circuit piping 130. In still other embodiments, the pump may be connected to a run time monitor (not shown) that records run time and controls run time to a pre-set limit or a pre-set schedule.

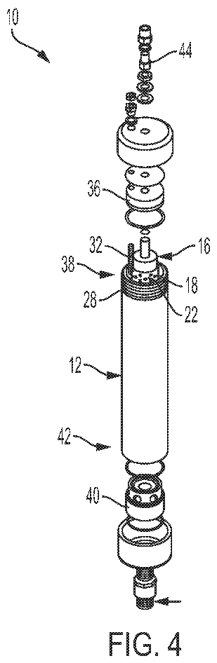

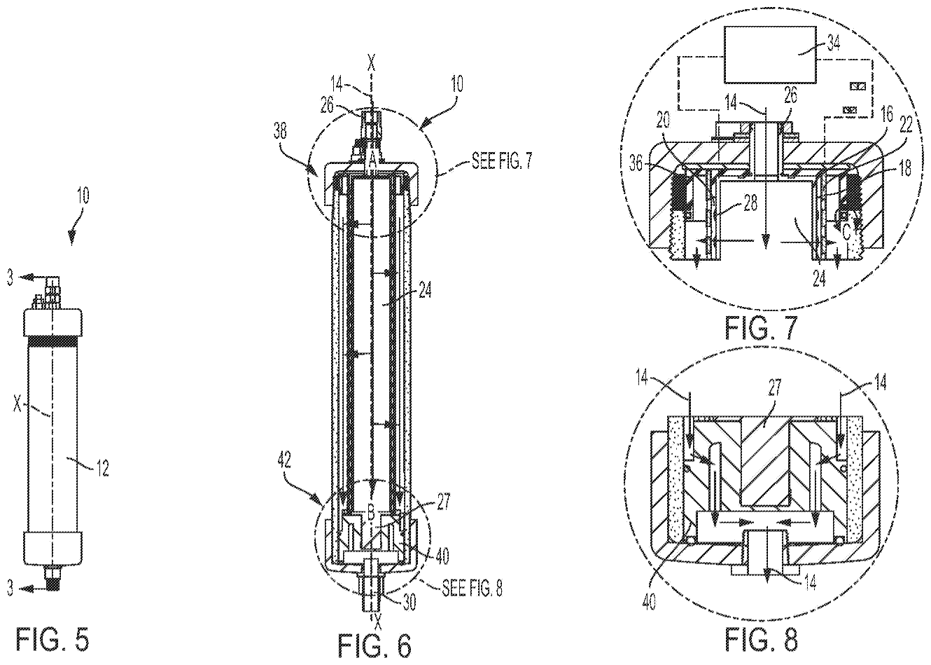

A flow-through electrochemical reactor 140 is disposed in, or connected to, the recirculation circuit piping 130. The flow-through electrochemical reactor 140 electrochemically remediates undesirable chemical compounds in wastewater flowing through the recirculation circuit piping 130, thereby treating the wastewater in the wastewater treatment system 100. One embodiment of a flow-through electrochemical reactor 140 is described below with respect to FIGS. 4-8.

In some embodiments, an optional pre-filter 142 and/or an optional post filter 144 may be included. The optional pre-filter 142 may filter out large particulates that might clog the electrochemical reactor 140. The optional post-filter 144 may filter and/or remediate particulates formed by the chemical reactions in the electrochemical reactor 140.

Generally, a portion of wastewater may be pumped from the distribution chamber 112, through the recirculation piping 130 to be treated in the flow-through electrochemical reactor 140, and returned to the treatment chamber 114. The portion of wastewater may be reintroduced into the treatment chamber by being released above the wastewater surface 133, as illustrated in FIG. 1. In other embodiments the portion of wastewater may be released below the wastewater surface 133, or the portion of wastewater may be released in the sludge layer 135 at a bottom of the wastewater tank 110. In yet other embodiments, the portion of wastewater may be released in a scum layer near the wastewater surface 133. In still other embodiments, the portion of wastewater may be reintroduced into either the distribution chamber or the treatment chamber.

Generally, the flow-through electrochemical reactor uses electricity to drive chemical reactions that mitigate undesirable chemical compounds in the wastewater. In some embodiments, the undesirable chemical compounds may comprise one or more of ammonia, Total Kjeldahl Nitrogen (TKN), biological oxygen demand (BOD), chemical oxygen demand (COD), pharmaceutical and personal care products (PPCPs), other anthropogenic compounds, metal oxyanions, or metal ions, or any combinations thereof.

Current wastewater treatment systems that rely on biological activity (such as septic tanks and cesspools) to break down waste do not eliminate nitrogen. This nitrogen then leaches into the soil where soil bacteria consume the organic nitrogen and ammonia and produce NOₓ (which is the sum of nitrate, nitrite, and nitrous oxide). The nitrates, nitrites, and nitrous oxide seep into the ground water where they can lead to algae blooms in open water (lakes, rivers, or oceans) where the water table empties. These algae blooms can be dangerous for humans and other wildlife and can cause economic disruption due to closed beaches and fisheries. One well known example of algae blooms that can be caused by NOₓ contamination is called “red tide,” but such algae blooms are generally classified as Harmful Algal Blooms (HABs).

In the illustrated embodiment, concentrations of the undesirable chemical compounds are lowered without the addition of other chemicals, and without producing large amounts of nitrates, nitrites, and NOₓ. More specifically, the system removes ammonia and organic nitrogen to prevent pollution of groundwater and nearby surface water. The electrochemical reactor transforms chloride present in the wastewater into hypochlorous acid (HOCl). The hypochlorous acid then reacts rapidly with ammonia and/or TKN to form, sequentially, monochloramine (NH₂Cl), dichloramine (NHCl₂), trichloramine (NCl₃), and finally nitrogen gas (N₂). The nitrogen gas then forms bubbles and is released to the atmosphere. Additionally, the system advantageously degrades carbonaceous wastes (as measured by BOD/COD), thereby enhancing the primary purpose of the septic tank and/or cesspool. In other embodiments, additional chemicals, such as an electrolyte salts, may be added upstream of the flow-through electrochemical reactor, or directly into the flow-through electrochemical reactor to enhance the desired chemical reactions in the flow-through electrochemical reactor.

Current septic systems and cesspools rely on biological actions to treat the wastewater. More specifically, bacteria are used to digest some undesirable portions of the wastewater. Current systems are therefore sensitive to temperature variations, specifically colder variations. As temperatures cool, biological activity slows. The wastewater treatment systems and methods described herein augment and supplement the biological activity with electrically driven chemical reactions. The electrically driven chemical reactions are insensitive to temperature changes unlike the biological activity. As a result, the disclosed wastewater treatment systems and methods advantageously maintain a high level of treatment over a wider range of temperature than known septic systems and cesspools.

Turning now to FIG. 2, a second embodiment of a wastewater treatment system 200 is illustrated. Where elements in the embodiment of FIG. 2 correspond to like elements in FIG. 1, the elements in FIG. 2 are numbered 100 greater than the like elements in FIG. 1. For example, the first embodiment of a wastewater treatment system in FIG. 1 is labeled with reference number 100, while the second embodiment of a wastewater treatment system in FIG. 1 is labeled with reference number 200.

The wastewater treatment system 200 of FIG. 2 includes a wastewater tank 210 having a distribution chamber 212 and a treatment chamber 214. The distribution chamber 212 includes a treated wastewater outlet 220, which is fluidly connected to a distribution baffle 221. The treatment chamber 214 includes an untreated wastewater inlet 224, which is fluidly connected to a treatment baffle 225. The distribution chamber 212 and the treatment chamber 214 may be fluidly separated by partition or a divider 215 that has a transfer baffle 217 so that liquid can flow from the treatment chamber 214 to the distribution chamber 212. In the embodiment of FIG. 2. A pump 232 is fluidly connected to the transfer baffle 217 and a flow-through electrochemical reactor 240 is disposed within, or connected to, the transfer baffle 217 so that a portion of wastewater from the treatment chamber 214 is pumped through the transfer baffle 217 and through the flow-through electrochemical reactor, where it is electrochemically treated before entering the distribution chamber 212. Like the embodiment of FIG. 1, the flow-through electrochemical reactor 240 electrochemically remediates undesirable chemical compounds in wastewater. The difference between the embodiment of FIG. 1 and the embodiment of FIG. 2 is the location of the flow-through electrochemical reactor and the location of the pump.

Any optional feature described above with respect to FIG. 1, may be combined with features of the embodiment of FIG. 2, and vice versa.

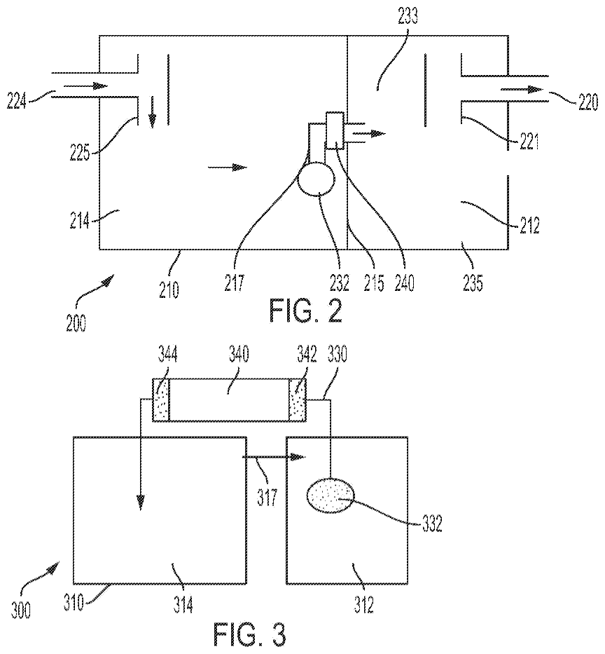

Turning now to FIG. 3, a third embodiment of a wastewater treatment system 300 is illustrated. Where elements in the embodiment of FIG. 3 correspond to like elements in FIG. 1 or FIG. 2, the elements in FIG. 3 are numbered 100 or 200 greater than the like elements in FIG. 1 or 2, respectively. For example, the first embodiment of a wastewater treatment system in FIG. 1 is labeled with reference number 100, and the second embodiment of a wastewater treatment system in FIG. 1 is labeled with reference number 200, while the third embodiment of a wastewater treatment system in FIG. 3 is labeled with reference number 300.

The third embodiment of the wastewater treatment system 300 is directed to an existing cesspool system that is modified to provide the electrochemical treatment described above. More specifically, the wastewater treatment system 300 includes an existing cesspool tank 310 that comprises a treatment chamber 314. A new in-ground holding tank is installed next to the cesspool tank 310. The new in-ground holding tank comprises a holding chamber 312. The treatment chamber 314 and the holding chamber 312 may be fluidly separated by a physical barrier, such as earth. A transfer pipe 317 may be installed to fluidly connect the treatment chamber 314 to the holding chamber 312, so that liquid can flow from the treatment chamber 314 to the holding chamber 312.

Recirculation circuit piping 330 (which forms a recirculation circuit) connects the holding chamber 312 to the treatment chamber 314. A pump 332 is fluidly connected to the recirculation circuit piping 330 and the pump 332 is adapted to pump a portion of wastewater from the holding chamber 312 to the treatment chamber 314 through the recirculation circuit piping 130. In the embodiment of FIG. 3, the pump 332 is a submersible pump that is located below a surface of liquid in the holding chamber 312. The pump 332 is located above a layer of sludge formed by solid matter that settles out of the wastewater over time. In other embodiments, the pump 332 may be a different type of pump (e.g., a wiz-bang pump, a positive displacement (non-submersible) pump, a suction pump, or the like), and/or the pump 332 may be located at another point in the system (e.g., above the surface of the wastewater in either the treatment chamber 314 or the holding chamber 312, or in the recirculation piping 330).

A flow-through electrochemical reactor 340 is disposed in, or connected to, the recirculation circuit piping 330. The flow-through electrochemical reactor 340 electrochemically remediates undesirable chemical compounds in wastewater flowing through the recirculation circuit piping 330, thereby purifying the wastewater in the wastewater treatment system 300.

Similar to the embodiment of FIG. 1, in some other embodiments an optional screen or pre-filter 342 and/or an optional post filter 344 may be included. The optional pre-filter 342 may filter out large particulates that might clog the electrochemical reactor 340. The optional post-filter 344 may filter and/or remediate particulates formed by the chemical reactions in the electrochemical reactor 340.

Like the embodiment of FIG. 1, a portion of wastewater may be pumped from the holding chamber 312, through the recirculation piping 330 to be treated in the flow-through electrochemical reactor 340, and returned to the treatment chamber 314. The portion of wastewater may be reintroduced into the treatment chamber by being released above the wastewater surface, below the wastewater surface, or in the sludge layer at a bottom of the wastewater tank 310. In yet other embodiments, the portion of wastewater may be released in a scum layer near the wastewater surface. In still other embodiments, the portion of wastewater may be reintroduced into either of the holding chamber 312 or the treatment chamber 314.

In any of the embodiments described above, a method of removing undesirable chemical compounds from wastewater in a wastewater treatment system includes introducing wastewater into a wastewater tank having a treatment chamber and a distribution chamber. A portion of the wastewater from the distribution chamber is pumped through a recirculation circuit. Undesirable chemical compounds in the portion of the wastewater in the recirculating circuit are electrochemically remediated by passing the portion of the wastewater through a flow-through electrochemical reactor.

Generally, wastewater is treated in septic systems by flowing directly from the treatment chamber to the distribution chamber. Waste is digested in the treatment chamber and entrained solids settle to the bottom of the treatment chamber. As a result, the fluid moving from the treatment chamber to the distribution chamber is mostly liquid with some dissolved solids, it is largely free of suspended solid particles. Wastewater from the distribution chamber is removed by a pump and passed through a flow-through electrochemical reactor before being returned to the treatment chamber. The flow-through electrochemical reactor and recirculation circuit are be external to existing septic tank (or cesspool) structure in some embodiments (e.g., the embodiments of FIGS. 1 and 3). In other embodiments, the flow-through electrochemical reactor may be placed in an existing fluid pathway between the treatment chamber and the distribution chamber (e.g., the embodiment of FIG. 2). Regardless, the wastewater treatment systems described herein advantageously are retrofittable to existing wastewater treatment structures. As a result, the modified wastewater treatment systems (with electrochemical reactors) are less expensive and more effective at treating wastewater than existing advanced nutrient removal systems.

In any of the embodiments described above, multiple electrochemical reactors may be placed in the fluid flow path between the treatment chamber and the distribution chamber. If more than one electrochemical reactor is located in a system, the electrochemical reactors may be identical (i.e., target the same (or similar) undesirable compounds) or the electrochemical reactors may be different (i.e., target different undesirable compounds). The reactors may be arranged in parallel and/or in series.

In yet other embodiments, municipal wastewater systems may be modified with the features and/or functions described herein. Generally, traditional municipal wastewater systems remove BOD through aeration. During aeration, nitrogenous wastes (primarily ammonia and/or TKN) are partially removed. Once the treated wastewater is reintroduced back into the environment, these nitrogen compounds can be transformed into nitrate, which can act as a nutrient for bacterial or algal growth. The systems and method described herein, more specifically the addition of a flow-through electrochemical reactor, transform these nitrogen compounds into less harmful compounds before the treated wastewater is released back into the environment.

Turning now to FIGS. 4-8, a flow-through electrochemical reactor 10 includes a housing 12 having a solution flow-path 14. A flow-through or solid first electrode, such as an anode 16, is disposed within the solution flow path 14. In the illustrated embodiment, the anode 16 is annulus-shaped, in some cases a hollow cylinder, comprising a porous material.

A second electrode, such as a cathode 18, is spaced apart from the anode 16, thereby creating an electroactive gap 20 between the anode 16 and the cathode 18. The electroactive gap 20 is less than 5 mm and greater than 2 mm. In the exemplified embodiment, the electroactive gap is about 3 mm. As mentioned above, the concentric arrangement of the anode 16 and the cathode 18 may be reversed.

In the illustrated embodiment, both the anode 16 and the cathode 18 have a hollow cylindrical shape. The anode 16 and the cathode 18 are arranged concentrically, the anode 16 being located within a cylindrical wall 22 of the cathode 20. The arrangement illustrated in FIGS. 1-5 may be used as an oxidizing reactor. In other embodiments, for example when used as a reducing reactor, the anode 16 and the cathode 18 may be reversed (such as by reversing electrical connections) so that the cathode 18 may be located within a cylindrical wall of the anode 16. Regardless, the anode 16 and the cathode 18 may share a common longitudinal axis x. An interior 24 of the anode 16 forms an initial flow path for the water/solution to be treated that enters the housing 12 through an inlet 26. As the water/solution to be treated fills the interior 24, it flows longitudinally, parallel to the longitudinal axis x and eventually reaches the bottom of the interior 24 where the liquid is stopped by a plug 27. Once stopped, pressure builds up in the interior 24, which forces the liquid to flow radially outward, perpendicular to the longitudinal axis x, through the wall of the anode 16.

The liquid may pass through the wall of the anode 16 through porous openings in the anode, or through perforations in the anode 16. Regardless, once the liquid flows through the wall of the anode 16, the liquid enters the electroactive gap 20. When in the electroactive gap 20, chemical reactions take place in the liquid, which are driven by the electron flow supplied by the charged anode and cathode. The liquid continues to flow radially outward through the cathode wall 22, for example through a plurality of openings 28 in the cathode wall 22. Once through the cathode wall 22, the liquid flows in the annular space formed between the cathode 18 and the housing 12, towards an outlet 30.

In alternate embodiments, one or both of the anode 16 and the cathode 18 may comprise solid cylindrical walls. In such embodiments, the flow path may enter the hollow interior of the anode 16, flow downward until contracting the plug 27, then around a bottom end of the anode 16, through a gap between a bottom of the anode 16 wall and the plug 27, then upward through the electroactive gap 20 until contacting the inlet cap 36 and through a gap between the inlet cap 36 and the top end of the cathode 18, then downward on the outside of the cathode 18 to the outlet.

A power source 34 is connected to the anode 16 and to the cathode 18 via an electrical connection 32. Usually, the power source will be a DC power source. However, an AC power source could alternatively be used. The power source 34 charges the anode 16 and the cathode 18 and water/solution being treated fills the electroactive gap 20, electrons flow between the anode 16 and the cathode 18 and the electricity provided drives certain desirable chemical reactions causing oxidation or reduction of contaminants and inactivation of pathogens.

An inlet cap 36 is disposed at a first end 38 of the housing 12, the inlet cap 36 maintains proper spacing and orientation of the anode 16 relative to the cathode 18. An outlet guide flow cap 40 is disposed at a second end 42 of the housing 12. The outlet guide flow cap 40 seals the second end 42 of the housing 12 and receives outlet flow from the exterior of the cathode 18. The outlet guide flow cap 40 also seals one end of the interior 24 of anode 24 in conjunction with the plug 27.

An adapter base inlet 44 is disposed at the first end 38 of the housing 12, the adapter base inlet 44 providing plumbing and electrical connections while maintaining a pressure seal.

The cathode 18 may comprise stainless steel, graphite, or other carbonaceous materials, dimensionally stable anodes (DSA), Magneli-phase titanium oxide (of general formula TiₙO₂ₙ₋₁, for example Ti₄O₇), mixed metal oxides (such as RuO₂ (ruthenium oxide), IrO₂ (iridium oxide), SnO (tin oxide) or PtO₂ (platinum oxide), or boron doped diamond (BDD), or a combination thereof. As used herein, the term “Magneli-phase titanium oxide” refers to a titanium oxide having general formula TiₙOₙ₋₁, for example, Ti₄O₇, Ti₅O₉, Ti₆O₁₁, or a mixture thereof. In an embodiment, the Magneli-phase titanium oxide may be Ti₄O₂. In other embodiments, the Magneli-phase titanium oxide may be a mixture of Magneli-phase titanium oxides.

The anode 16 may comprise one of dimensionally stable anodes (DSA), Magneli-phase titanium oxide (of general formula TiₙO₂ₙ₋₁, for example Ti₄O₇), mixed metal oxides (such as RuOₓ (ruthenium oxide), IrOₓ (iridium oxide), SnO (tin oxide) or PtOₓ (platinum oxide), boron doped diamond (BDD), others, or a combination thereof.

Once an appropriate flow-through reactor is constructed and arranged, the power is applied to the cathode(s) and the anode(s), and water/solution to be treated is passed through the electrodes resulting in electrochemical purification thereof. The purified water/solution is subsequently removed from the reactor. The applied power may be reversed periodically to prevent passivation of the electrodes and to remove foulants. In this embodiment, the cathode may include a sub-stoichiometric titanium oxide or other electrode material. The reactor may be periodically backwashed to purge built up solids that may have accumulated in the pores or openings of the electrode.

In the illustrated embodiment, during use, power is applied to the cathode and the anode, and the influent water is transferred to the inlet cap end of the reactor and into the tubular path located vertically in the center of the reactor. The influent water exits from the outlet of the tube. Typically, the orientation of the reactor is positioned (and thus rotated 180 degrees relative to the illustrations depicted in the FIGS.) so that the inlet is disposed at the bottom and the outlet is disposed at the top. In such an arrangement, the influent water flows from bottom to top. In other embodiments, the anode and cathode may be reversed, as discussed above.

The flow-through reactor, according to any embodiment, may further optionally include an oxidation-reduction potential sensor, a pH sensor, a chlorine sensor, a conductivity sensor, a flow rate sensor, a pressure sensor, a temperature sensor, one or more contaminant sensors (such as nitrogen, TOC, UV-Vis, etc.), or a combination thereof.

Some advantages for using the disclosed flow-through electrochemical reactors for electrochemical water treatment are high corrosion resistance to acidic and basic solutions, high electrical conductivity, increased mass transfer, and electrochemical stability.

The solution may comprise a solution of a metal chloride, such as sodium chloride, in deionized water, tap water, or source water. The metal chloride may be an alkali metal chloride, an alkaline earth metal chloride, a combination thereof, but is not limited thereto. The water/solution to be treated may include a variety of living microorganisms, anthropogenic compounds, natural compounds, or any combination thereof. The microorganism may be a bacterium, a virus, a protozoa, or others. Different kinds of microorganisms may be simultaneously present.

Chlorine and other oxidants (including, but not limited to, ozone and hydroxyl radicals) generated by the disclosed flow-through electrochemical reactors synergistically work together to purify the solution being treated.

The influent liquid may also include various anthropogenic compounds. Many of these compounds are carcinogens and are highly dangerous for human and animal health. These compounds may be efficiently oxidized to less harmful oxidation products.

Any feature of a wastewater treatment system illustrated in the embodiments of FIGS. 1-3 may be combined with or substituted for an element in any of the other embodiments of FIGS. 1-3. Similarly, the embodiment of a flow-through electrochemical reactor illustrated in FIGS. 4-8 may be employed in any of the wastewater treatment systems of FIGS. 1-3. When incorporated into any of the embodiments of a wastewater treatment system of FIGS. 1-3, the flow-through electrochemical reactor may include any one or more of the optional features or forms described in FIGS. 4-8.

### EXAMPLES

Example 1: A flow-through electrochemical reactor constructed in accordance with the embodiment illustrated in FIGS. 4-8 was tested in remediating waste water typically found in septic tanks. The test waste water comprised 57.5 mg/L TKN, 3.09 mg/L Ammonia and 0.0454 mg/L NOₓ before power was applied to the flow-through electrochemical reactor. The test waste water also had an initial pH of 7.53, and an initial conductivity of 3.35 ms/cm. Power was applied to the flow-through electrochemical reactor at a voltage of 7.5 V and a current of 25 A, and the test waste water was circulated at 3 to 5 gpm. At the beginning of the test, 26 g of NaCl was added to facilitate oxidation of contaminants. The test results of Example 1 are summarized below in Table 1.

TABLE 1

| Time | | Current | Conductivity | Temperature | | | TKN | Ammonia | NOₓ |
|---|---|---|---|---|---|---|---|---|---|
| (min) | Voltage | (Amp) | (ms/cm) | (F.) | pH | ORP | (mg/L) | (mg/L) | (mg/L) |
| 0 | 7.66 | 25 | 3.35 | NA | 7.53 | 203 | 57.5 | 3.09 | 0.0454 |
| 20 | 7.51 | 25 | 2.93 | NA | 7.73 | 678 | 40.9 | 2.24 | 0.176 |
| 40 | 7.4 | 25 | 3.23 | 75.9 | 6.92 | 879 | 30.2 | 0.729 | 0.385 |
| 60 | 7.34 | 25 | 3.78 | 79.7 | 7.41 | 860 | 24.9 | 0.385 | 0.661 |
| 80 | 7.25 | 25 | 3.87 | 82.6 | 7.57 | 863 | 21.9 | 0.309 | 1.02 |
| 100 | 7.21 | 25 | 3.31 | 85.1 | 7.63 | 860 | 17.9 | 0.274 | 1.34 |
| 120 | 7.19 | 25 | 3.1 | 87.3 | 7.63 | 854 | 16.6 | 0.253 | 1.6 |

Example 2: The initial test conditions set forth above with respect to the flow-through electrochemical reactor and the test waste water of Example 1 were identical for Example 2. However, the power applied to the flow-through electrochemical reactor in Example 2 was at a voltage of 11 V and a current of 50 A and the test waste water was again circulated at 3 to 5 gpm. At the beginning of the test, 40 g of NaCl was added to facilitate oxidation of contaminants. The test results of Example 2 are summarized in Table 2 below:

TABLE 2

| Time | | Current | Conductivity | Temperature | | | TKN | Ammonia | NOₓ |
|---|---|---|---|---|---|---|---|---|---|
| (min) | Voltage | (Amp) | (ms/cm) | (F.) | pH | ORP | (mg/L) | (mg/L) | (mg/L) |
| 0 | 11.58 | 50 | 2.93 | 66.4 | 8.48 | 337 | 45.3 | 2.62 | 0.233 |
| 20 | 11.23 | 53 | 2.78 | 77.5 | 7.58 | 866 | 24.7 | 0.329 | 0.743 |
| 40 | 11 | 53 | 2.59 | 87.6 | 7.83 | 841 | 16.4 | 0.289 | 1.92 |
| 60 | 10.83 | 53 | 2.35 | 96.1 | 7.81 | 825 | 13.5 | 0.288 | 2.85 |
| 80 | 10.41 | 50 | 1.96 | 102.6 | 7.8 | 813 | 11.7 | 0.351 | 3.55 |
| 92 | NA | NA | 2.1 | 105.3 | 7.8 | 810 | 12 | 0.368 | 3.84 |

The test results set forth above in Tables 1 and 2 show that the flow-through electrochemical reactor advantageously destroyed over 80% of the organic nitrogen in the test waste water while maintaining relatively stable pH, which maintains a stable environment for biological agents otherwise present in the septic system to act on other waste products. Unexpectedly, very little nitrate, nitrite, or nitrous oxide was formed, which indicates that most of the destroyed organic nitrogen was converted into harmless nitrogen gas, N₂. The evolution (and loss) of N₂ from the system was confirmed by the difference between Total Nitrogen (corresponding to the sum of TKN and NOₓ) at time 0 and the end of the test.

ORP in the tables above stands for Oxidation/Reduction Potential, which is a measure of the amount of oxidation potential (positive number) or reduction potential (negative number) of the system. The higher the value, the higher the oxidation potential (or reduction potential) and thus the capacity to oxidize or reduce chemical moieties. In the tables above, the increase in ORP as the testing progressed corroborates the efficacy of the electrochemical reactor in this environment, as this measurement confirms the production of oxidizing agents, such as chlorine, by the electrochemical reactor.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A wastewater treatment system comprising:
a wastewater tank including a distribution chamber and a treatment chamber, the distribution chamber including a treated wastewater outlet and a recirculation circuit inlet, the treatment chamber including an untreated wastewater inlet and a recirculation circuit exit;
recirculation circuit piping connecting the recirculation circuit inlet to the recirculation circuit exit;
a pump fluidly connected to the recirculation circuit inlet and the pump being adapted to pump a portion of wastewater from the distribution chamber to the treatment chamber through the recirculation circuit; and
a flow-through electrochemical reactor disposed in the recirculation circuit, the flow-through electrochemical reactor being adapted to electrochemically remediate undesirable chemical compounds in wastewater flowing through the recirculation circuit.

2. The wastewater treatment system of claim 1, wherein the pump is a pump disposed in the distribution chamber.

3. The wastewater treatment system of claim 1, wherein the wastewater tank is a septic tank.

4. The wastewater treatment system of claim 1, wherein the distribution chamber is separated from the treatment chamber by a divider.

5. The wastewater treatment system of claim 1, wherein a baffle is connected to one of the wastewater inlet or the wastewater outlet.

6. The wastewater treatment system of claim 1, wherein the treatment chamber comprises an existing cesspool and the distribution chamber comprises a separate in-ground tank.

7. The wastewater treatment system of claim 1, wherein the flow-through electrochemical reactor comprises an electrode and a cathode.

8. The wastewater treatment system of claim 1, wherein the flow-through electrochemical reactor comprises a housing including a solution flow-path, a flow-through or solid first electrode disposed within the solution flow-path, a second electrode spaced apart from the flow-through or solid first electrode creating an electroactive gap between the flow-through or solid first electrode and the second electrode.

9. The wastewater treatment system of claim 8, wherein the electroactive gap is less than 5 mm and greater than 2 mm.

10. The wastewater treatment system of claim 8, wherein the first electrode is an anode having a hollow cylindrical shape.

11. The wastewater treatment system of claim 8, wherein the second electrode is a cathode having a hollow cylindrical shape.

12. The wastewater treatment system of claim 8, wherein the first electrode has an annulus shape and the second electrode has an annulus shape, and the first electrode and the second electrode are arranged concentrically, the first electrode being located within a wall of the second electrode.

13. The wastewater treatment system of claim 8, wherein the solution flow path extends radially, through a wall of the first electrode, radially across the electroactive gap, and radially through a wall of the second electrode.

14. The wastewater treatment system of claim 8, further comprising a power source connected to the first electrode and to the second electrode thereby creating an electrical circuit.

15. The wastewater treatment system of claim 8, wherein the second electrode comprises one of stainless steel, graphite, or other carbonaceous materials, dimensionally stable anode (DSA), Magneli-phase titanium oxide, mixed metal oxide, or boron doped diamond (BDD).

16. The wastewater treatment system of claim 8, wherein the first electrode comprises one of dimensionally stable anodes (DSA), Magneli-phase titanium oxide, mixed metal oxides, or boron doped diamond (BDD).

17. A method of removing undesirable chemical compounds from wastewater in a wastewater treatment system, the method comprising:
introducing wastewater into a wastewater tank including a treatment chamber and a distribution chamber;
pumping a portion of the wastewater from the distribution chamber and through a recirculation circuit; and
electrochemically remediating undesirable chemical compounds in the portion of the wastewater in the recirculating circuit by passing the portion of the wastewater through a flow-through electrochemical reactor.

18. The method of claim 17, further comprising returning the portion of the wastewater to the treatment chamber after passing through the flow-through electrochemical reactor.

19. The method of claim 17, wherein the portion of the wastewater is reintroduced into one of the distribution chamber and the treatment chamber after passing through the electrochemical reactor either by releasing above a surface of the wastewater in the wastewater tank, releasing below a surface of the wastewater in the wastewater tank, releasing in a sludge layer at a bottom of the wastewater tank, or releasing in a scum layer at a top of the wastewater in the wastewater tank.

20. The method of claim 17, wherein the undesirable chemical compounds comprise one of nitrate, perchlorate, borate, pharmaceutical and personal care products (PPCPs), metal oxyanions, metal ions, and combinations thereof.

21. The method of claim 17, wherein concentrations of the undesirable chemical compounds are lowered without the addition of other chemicals.

22. A wastewater treatment system comprising:
a wastewater tank including a distribution chamber and a treatment chamber, the distribution chamber including a treated wastewater outlet and a flow-through outlet, the treatment chamber including an untreated wastewater inlet and a flow-through inlet;
flow-through piping connecting the flow-through inlet to the flow-through exit;
a pump fluidly connected to the flow-through piping and the pump being adapted to pump a portion of wastewater from the treatment chamber to the distribution chamber through the flow-through piping; and
a flow-through electrochemical reactor fluidly connected to the flow-through piping, the flow-through electrochemical reactor being adapted to electrochemically remediate undesirable chemical compounds in wastewater flowing through the flow-through piping.
